(19) United States
(12) Patent Application Publication
(10) Pub. No.: US 2018/0275837 A1
(43) Pub. Date: Sep. 27, 2018

(54) GRAPHICAL USER INTERFACE (GUI) CONTROLS

(71) Applicant: RideOn Ltd., Haifa (IL)

(72) Inventors: Alon Getz, Haifa (IL); Avi Rogalsky, Netanya (IL); Samuel Alexander Rabinovich, Kiryat-Ata (IL)

(21) Appl. No.: 15/927,177

(22) Filed: Mar. 21, 2018

Related U.S. Application Data
(60) Provisional application No. 62/475,256, filed on Mar. 23, 2017.

(51) Int. Cl. G06F 3/0482; G06F 3/0484; G06F 3/01; G02B 27/01

(52) U.S. Cl. CPC G06F 3/0482; G02B 27/017; G06F 3/012; G06F 3/04842

(57) ABSTRACT

A system for controlling a menu based augmented reality (AR) Graphical User Interface (GUI) according to predefined head movement positions, comprising a head mounted AR display and one or more hardware processors adapted to execute a code, the code comprising code instructions to present one or more selection menus of a GUI displayed by the head mounted AR display, the selection menu(s) comprising one or more control display objects, code instructions to detect one or more predefined discrete head movement positions of the head mounted display by analyzing sensory data received from one or more orientation sensors monitoring orientation of the head mounted display, each of the predefined discrete head movement positions maps one of a plurality of navigation actions and code instructions to apply a respective navigation action mapped by the detected predefined discrete head movement position(s) on a currently pointed control object of the control display objects.

### RELATED APPLICATIONS

This application claims the benefit of priority under 35 USC § 119(e) of U.S. Provisional Patent Application No. 62/475,256 filed on Mar. 23, 2017, the contents of which are incorporated herein by reference in their entirety.

### FIELD AND BACKGROUND OF THE INVENTION

The present invention, in some embodiments thereof, relates to controlling a Graphical User Interface (GUI) and, more particularly, but not exclusively, to controlling an Augmented Reality (AR) GUI using predefined discrete head movement positions.

The use of AR devices, system and/or platforms is rapidly increasing for a plurality of applications, for example, military applications, aviation applications, gaming applications, sports activities applications, navigation applications, touristic applications and/or the like. Typically, the AR devices are used to enhance the real world view with an AR display presentation in which synthetically generated symbols may be overlaid on a presentation surface of the AR device, for example, a visor, a lens and/or the like.

Often the AR display presents a GUI allowing the user to control the AR display presentation and/or to initiate one or more actions and/or operations in the AR device and/or in one or more device connected to the AR device, for example, a Smartphone, a tablet, a Smart watch and/or the like.

Providing a simple, user friendly and/or effective user interface for controlling the GUI may present a major challenge. While the user interface may typically be a tactile interface using touch screens, buttons, etc. and/or a voice activation interface, many of the AR applications may require hands free interaction and/or may be incapable of supporting voice activation due to a plurality of reasons, for example, noisy environment, inability to issue voice commands and/or the like.

### SUMMARY OF THE INVENTION

According to a first aspect of the present invention there is provided a system for controlling a menu based augmented reality (AR) Graphical User Interface (GUI) according to predefined head movement positions, comprising a head mounted AR display and one or more hardware processors adapted to execute a code, the code comprising:
Code instructions to present one or more selection menus of a GUI displayed by the head mounted AR display, the one or more selection menus comprising one or more of a plurality of control display objects.
Code instructions to detect one or more of a plurality of predefined discrete head movement positions of the head mounted display by analyzing sensory data received from one or more orientation sensor monitoring orientation of the head mounted display, each of the plurality of predefined discrete head movement positions maps one of a plurality of navigation actions.
Code instructions to apply a respective navigation action mapped by the one or more detected predefined discrete head movement positions on a currently pointed control object of the plurality of control display objects.
   Using the orientation of the head mount AR device (induced by the user) to navigate through the GUI may provide a hands free user interface relieving the user from using his hands for controlling the GUI. Moreover, controlling the GUI according to head movements of the user, may allow using the head mount AR device in noisy environments and/or in a plurality of applications in which voice activation may not be feasible. Furthermore, predefining the discrete head movement positions as discrete (short) finite movement to an adjacent (near) position which may be easily distinguishable from each other may significantly improve accuracy of detection and classification of the calculated head mount orientation to one of the predefined discrete head movement positions. In addition, by mapping the predefined discrete head movement positions according to natural, culturally customary and/or popular head movements, navigation through the GUI may be intuitive allowing for simple navigation and a steep learning curve.

According to a second aspect of the present invention there is provided a computer implemented method of controlling a menu based augmented reality (AR) Graphical User Interface (GUI) according to predefined head movement positions, comprising:
Presenting one or more selection menus of a GUI displayed on an AR display of a head mounted display, the one or more selection menus comprising one or more of a plurality of control display objects.
Detecting one or more of a plurality of predefined discrete head movement positions of the head mounted display by analyzing sensory data received from one or more orientation sensors monitoring orientation of the head mounted display, each of the plurality of predefined maps one of a plurality of navigation actions.
Applying a respective navigation action mapped by the one or more detected predefined discrete head movement positions on a currently selected control display object of the plurality of control display objects.

In a further implementation form of the first and/or second aspects, the one or more orientation sensors are members of a group consisting of: an accelerometer, a gyroscope, a Global Positioning System (GPS) sensor and an altitude sensor. This may allow integrating the system with a plurality of sensors allowing high integration flexibility and easy migration and/or implementation of the system for a plurality of applications, systems and/or platforms.

In a further implementation form of the first and/or second aspects, the one or more orientation sensors are integrated in the head mounted display. This may serve to simplify the system by providing an integrated solution through the head mount display and/or the head mount thus avoiding cumbersome implementation comprising a plurality of separate elements, components and/or devices.

In a further implementation form of the first and/or second aspects, the one or more processors are integrated in the head mounted display. This may further serve to simplify the system by providing an integrated solution through the head mount display and/or the head mount thus avoiding cumbersome implementation comprising a plurality of separate elements, components and/or devices.

In a further implementation form of the first and/or second aspects, each of the plurality of predefined discrete head movement positions defines a movement vector in a single direction from a reference position to a position in a 3-dimension (3D) space of the head mounted display. Navigation in a single movement vector may improve the detection and/or classification accuracy of the calculated orientation of the head mount to the discrete head movement positions.

In a further implementation form of the first and/or second aspects, the navigation action is a member of a group consisting of: move left, move right, move up, move down, move diagonally up, move diagonally down, move clockwise, move counterclockwise, move inwards, move outwards, select, confirm selection, initiate an application function and return to a previous selection menu. Assigning a discrete head movement position for each of the commonly used menu navigation actions may allow flexibility in constructing the selection menus. This may further support the intuitive mapping of the discrete head movement positions to their respective navigation action.

Optionally, in a further implementation form of the first and/or second aspects, the code comprises code instructions to present one or more selection sub-menus on the AR display in response to selection of the one or more control display objects. This may allow presenting further functionality to the user by expanding the selected control display object(s) to present the user with additional actions and/or operations.

In a further implementation form of the first and/or second aspects, the one or more selection menus are scrollable back and forth along a single axis. The improved detection achieved by the discrete head movement positions predefinition coupled with the single axis navigation through the selection menus may improve control/navigation of the GUI since the navigation actions may be simply performed by the user and accurately detected by the AR display controller. This may further reduce and/or eliminate altogether false detection of head movements and/or false detection of the head movements which may result in selecting wrong navigation action(s).

In a further implementation form of the first and/or second aspects, the one or more of the plurality of control display objects is associated with one of a plurality of application functions of one or more applications. The code comprises code instructions to execute a respective application function associated with the one or more control display objects in response to selection confirmation of the one or more control display objects. This may allow the user to take one or more actions be selecting the associated control display object in the selection menu(s).

Optionally, in a further implementation form of the first and/or second aspects, the code comprises code instructions to navigate rapidly by repeating one or more of the plurality of navigation actions is repeated according to a time interval during which the head mounted display is maintained in a respective one of the plurality of predefined discrete head movement positions mapping the one or more navigation actions. This may allow for rapid navigation through the selection menu from one control display object to the next (or previous) instead of repeating the same predefined discrete head movement position over and over.

Optionally, in a further implementation form of the first and/or second aspects, the code comprises code instructions to calibrate the one or more orientation sensors according to one or more of the plurality of predefined discrete head movement positions of the head mounted display during a calibration session. Calibrating the head mount orientation reference may significantly improve the head mount orientation calculation as the head mount changes its orientation (typically induced by head movements of the user). By providing a GUI interface the orientation sensors may be accurately calibrated according to the known predefined discrete head movement positions.

Optionally, in a further implementation form of the first and/or second aspects, the code comprises code instructions to calibrate the one or more orientation sensors according to the one or more predefined discrete head movement positions of the head mounted display while navigating through the one or more selection menus. Dynamically calibrating the orientation sensors during operation and/or use of the head mount may allow compensating for offsets accumulated over time and reset the head mount orientation reference to a known state.

Optionally, in a further implementation form of the first and/or second aspects, the code comprises code instructions to disable at least some of the plurality of navigation actions based on analysis of sensory data received from one or more activity sensors, the one or more activity sensors is a member of a group consisting of: the one or more orientation sensors, a GPS sensor and an altitude sensor. By disabling the navigation actions and/or part thereof when the user is detected to be unable to control the GUI through the head movements, unwanted and/or unintentional head movements may not be applied to navigate and/or operate the selection menus thus avoiding from unwanted and/or unintentional operations and/or actions.

Optionally, in a further implementation form of the first and/or second aspects, the code comprises code instructions to use one or more machine learning algorithms to correlate one or more head movement position patterns of one or more users using the head mount display with one or more of the plurality of predefined head movement positions. This may allow adjusting the detection and/or classification of the calculated head mount orientation to the predefined head movement positions according to personal head movement patterns identified for the user(s) thus improving detection and/or classification accuracy.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of an exemplary system for controlling a menu based AR GUI according to predefined head movement positions, according to some embodiments of the present invention;

FIG. 2 is a flowchart of an exemplary process of controlling a menu based AR GUI according to predefined head movement positions, according to some embodiments of the present invention;

FIG. 3 is a schematic illustration of an exemplary GUI of an AR display, according to some embodiments of the present invention;

FIG. 4 is a schematic illustration of an exemplary head mount display;

FIG. 5 is a schematic illustration of an exemplary set of predefined head movement positions, according to some embodiments of the present invention;

FIG. 6 is a schematic illustration of an exemplary calibration GUI for calibrating a head mount display, according to some embodiments of the present invention;

FIG. 7 is a schematic illustration of exemplary sequences for navigating through an exemplary vertical selection menu of a GUI of an AR display, according to some embodiments of the present invention;

FIG. 8 is a schematic illustration of exemplary sequences for navigating through an exemplary horizontal selection menu of a GUI of an AR display, according to some embodiments of the present invention;

FIG. 9 is a schematic illustration of exemplary sequences for navigating through an exemplary radial selection menu of a GUI of an AR display, according to some embodiments of the present invention;

FIG. 10 is a schematic illustration of exemplary sequences for navigating through an exemplary global selection menu of a GUI of an AR display, according to some embodiments of the present invention; and

FIG. 11 is a schematic illustration of exemplary main display area presentations, according to some embodiments of the present invention.

### DESCRIPTION OF SPECIFIC EMBODIMENTS OF THE INVENTION

The present invention, in some embodiments thereof, relates to controlling a GUI and, more particularly, but not exclusively, to controlling an AR GUI using predefined discrete head movement positions.

According to some embodiments of the present invention, there are provided methods, systems and computer program products for controlling a GUI of an AR display presentation using predefined discrete head movement positions. The AR display may be presented on a presentation surface, for example, a visor, a lens and/or the like of a head mount AR device. The AR display may comprise a GUI, in particular, one or more selection menus each comprising one or more control display objects. One or more of the control display objects may be associated with an action, an operation, an application function and/or the like. The selection menu(s) may be constructed to allow back and/or forth scrolling, advancing and/or navigating through the control display objects in a single direction (axis), for example, up/down, right/left, clockwise/counterclockwise and/or the like.

The orientation of the head mount AR device may be monitored by one or more orientation sensors, for example, an accelerometer, a gyroscope, an Inertial Measurements Unit (IMU) and/or the like. An AR display controller may obtain sensory data from the orientation sensors and calculate a current orientation of the head mount AR device.

The AR display controller may compare the calculated orientation, movement and/or positioning of the head mount AR device to a plurality of predefined discrete head movement positions. Each of the predefined discrete head movement positions defines a distinct and short movement vector in a single direction to an adjacent position in the 3-dimension (3D) space of the head mount AR device. In particular, the movement vector of each predefined discrete head movement position may define a movement vector between the respective distinct position and a reference position. Each of the predefined discrete head movement positions may map one of a plurality of navigation actions for navigating through the GUI, for example, move left, move right, move up, move down, move diagonally up, move diagonally down, move clockwise, move counterclockwise, move inwards, move outwards, select, confirm selection, initiate an application function, return to a previous selection menu and/or the like. Mapping of the navigation actions may in practice be done to movement vector in a single direction from the reference position to the position indicated by the respective predefined discrete head movement positions and optionally back to the reference position. The mapping of the predefined discrete head movement positions to the navigation actions may employ natural human movements to provide an intuitive user interface.

Based on the comparison, the AR display controller may detect a match of the calculated orientation, movement and/or positioning of the head mount AR device with one or more of the predefined discrete head movement positions. The AR display controller may select the navigation action mapped by the detected matching predefined discrete head movement position(s) and may apply the selected navigation action to the control display object currently pointed (selected).

Optionally, the AR display controller may repeat a certain navigation action in response to a prolonged time duration in which the orientation of the head mount AR device is maintained in the predefined discrete head movement position mapping the certain navigation action.

Optionally, the AR display controller may disable one or more of the GUI selection menus and/or one or more of the control display objects based on analysis of one of more activity sensors, for example, a GPS, an altitude sensor, a tracking device and/or the like. Based on the analysis, the AR display controller may determine the activity state and/or conditions of a user using the head mount AR device. In case the AR display controller determines that the user may be engaged in an activity that may prevent him from properly controlling and/or navigating through the GUI, the AR display controller may disable the GUI and/or part thereof. Similarly, in case the AR display controller determines that the user may be capable of properly controlling and/or navigating through the GUI, the AR display controller may enable the GUI and/or part thereof.

Optionally, the AR display controller may calibrate an orientation reference of the head mount AR device during a calibration session and/or during normal operation of the AR display presentation.

Optionally, the AR display controller may employ one or more machine learning mechanisms to identify orientation, movement and/or positioning patterns of the head mount AR device when used by one or more users.

Controlling the AR display GUI using the predefined discrete head movement positions may present significant advantages compared to existing methods for controlling an AR display GUI. First, by using the orientation of the head mount AR device which may be induced by head movements of the user may provide a hands free user interface relieving the user from using his hands for controlling the GUI as may be done by some of the existing methods. In addition, by controlling the GUI according to head movements of the user, the head mount AR device may be used in noisy environments and/or in a plurality of applications in which voice activation (as may be employed by some of the existing methods) may not be feasible.

Moreover, predefining the discrete head movement positions as discrete (short) finite movement to an adjacent (near) position which may be easily distinguishable from each other may significantly improve accuracy of detection and classification of the calculated head mount orientation to one of the predefined discrete head movement positions. The improved detection coupled with constructing the GUI section menus with single direction advancement, may provide for improved control/navigation through the GUI since the navigation actions may be simply performed by the user and accurately detected by the AR display controller. This may further reduce and/or eliminate altogether false detection of head movements and/or false detection of the head movements which may result in selecting wrong navigation action(s).

Furthermore, by mapping the predefined discrete head movement positions according to natural, culturally customary and/or popular head movements, navigation through the GUI may be intuitive allowing for simple navigation and a steep learning curve.

Also, by enabling and disabling the GUI and/or part thereof according to an estimated activity state and/or condition(s) of the user, may prevent unintentional and/or erroneous navigation actions initiated by the user while he is not fully capable of controlling the GUI. This may also serve for increased security for the user and/or his environment since by disabling the GUI, the user may not be distracted with attempts to control and/or navigate through the GUI.

Additionally, by employing the machine learning mechanism(s), head movement patterns of a plurality of users may be analyzed and the predefined discrete head movement positions may be adjusted comply with the head movements of a plurality of users. Moreover, using the machine learning mechanism(s), head movement patterns of one or more users may be learned and identified during a plurality of usage sessions. The predefined discrete head movement positions may therefore by adapted according to head movement patterns of specific users thus improving the calculation, matching and/or detection of the head mount AR device orientation to the predefined discrete head movement positions.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

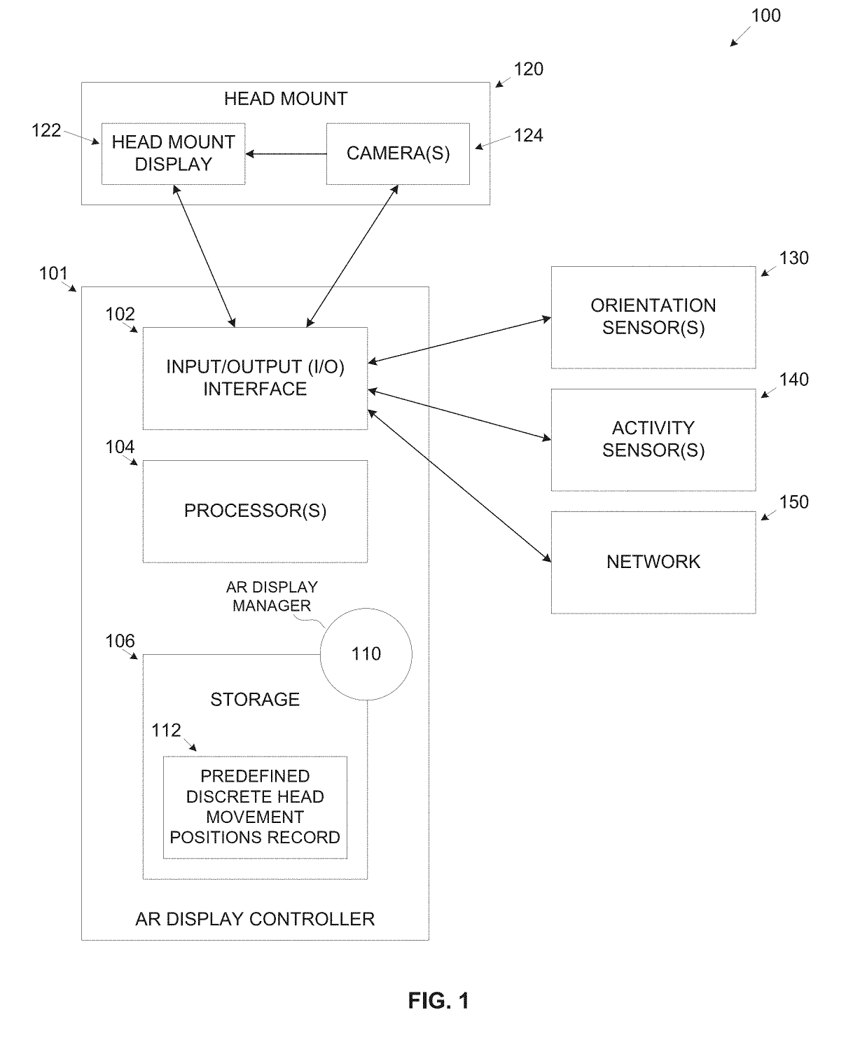

Referring now to the drawings, FIG. 1 is a schematic illustration of an exemplary system for controlling a menu based AR GUI according to predefined head movement positions, according to some embodiments of the present invention. An exemplary system 100 includes head mount 120, for example, a helmet, a head strap and/or any suitable head mount that may be attached to a head of a user. The head mount 120 may include a head mount display 122 presenting an AR display overlaying a synthetically generated presentation over real world image(s) view. The head mount display 122 may present the AR display as known in the art, for example, on a transparent visor of the head mount 120, on one or more lenses of the head mount 120 and/or the like. Optionally, the head mount 120 may include one or more cameras 124 which may be integrated, attached and/or coupled with the head mount 120. The system 200 may include an AR display controller 101 comprising an Input/output (I/O) interface 102, a processor(s) 104 and a storage 106.

The system 100 includes one or more orientation sensors 130, for example, an accelerometer, a gyroscope, an IMU and/or the like which monitor orientation, movement, and/or position of the head mount display 120. Optionally, the system 100 includes one or more activity sensors 140, for example, a GPS, an altitude sensor, a tracking device and/or the like.

In some embodiment, the AR display controller 101 is integrated in the head mount display 120.

In some embodiment, the orientation sensor(s) 130 are integrated in the head mount display 120.

In some embodiment, the activity sensor(s) 140 are integrated in the head mount display 120.

The I/O interface 102 may include one or more interfaces, ports, channels and/or the like for connecting to one or more peripheral devices, networks and/or the like. In particular, the I/O interface 102 includes one or more interfaces for connecting and driving an AR display presented by the head mount display 122. The I/O interface 102 may further include one or more wired and/or wireless interfaces for connecting to the orientation sensor(s) 130 and/or the activity sensor(s) 140. The I/O interface 102 may further include one or more wireless network interfaces for connecting to one or remote networked nodes through one or more networks 150, for example, Wireless Local Area Network (WLAN) (e.g. Wi-Fi), cellular network and/or the like. For example, the I/O interface 102 may be used to connect to one or more client terminals, for example, a smartphone, a tablet, a laptop, a computer and/or the like. The I/O interface 102 may further be used to connect to one or more remote networked resources, for example, the internet, a server, a cloud service, a remote service and/or the like.

The processor(s) 104 may comprise one or more one or more processors (homogenous or heterogeneous), which may be arranged for parallel processing, as clusters and/or as one or more distributed core processing units. The processor(s) 104 may further include one or more Graphic Processing Units (GPU) for rendering, driving and/or controlling the head mount display 122 for presenting the AR display. The processor(s) 104 may execute one or more software modules, for example, a process, an application, an agent, a utility, a service and/or the like wherein a software module refers to a plurality of program instructions executed by the processor(s) 104 from the storage 106 storage. The processor(s) 104 may execute, for example, an AR display manager 110 for generating, managing, fusing, controlling, rendering and/or the like the AR display presented by the head mount display 122. The AR display manager 110 may create the AR display, for example, by overlaying the synthetic presentation on a presentation surface, for example, a visor, a lens and/or the like of the head mount 120 through which real world view may be seen. Optionally, the AR display manager 110 may create the AR display by fusing the synthetic presentation with one or more image(s) captured by the camera(s) 124 which may provide the captured image(s) to the AR display manager 110 or directly to the head mount display 122. One or more records, for example, a list, a database, a table and/or the like may be stored in the storage 106. For example, a predefined discrete head movement positions record 112 may be stored in the storage 106.

The storage 106 may include one or more non-transitory persistent storage devices, for example, a Read Only Memory (ROM), a Flash device, a hard drive, an attachable storage media and/or the like. The storage medium may further include one or more volatile storage devices, for example, a random access memory (RAM) to which one or more software modules may be loaded from one or more of the non-transitory storage devices and/or from one or more remote resources over the network 150.

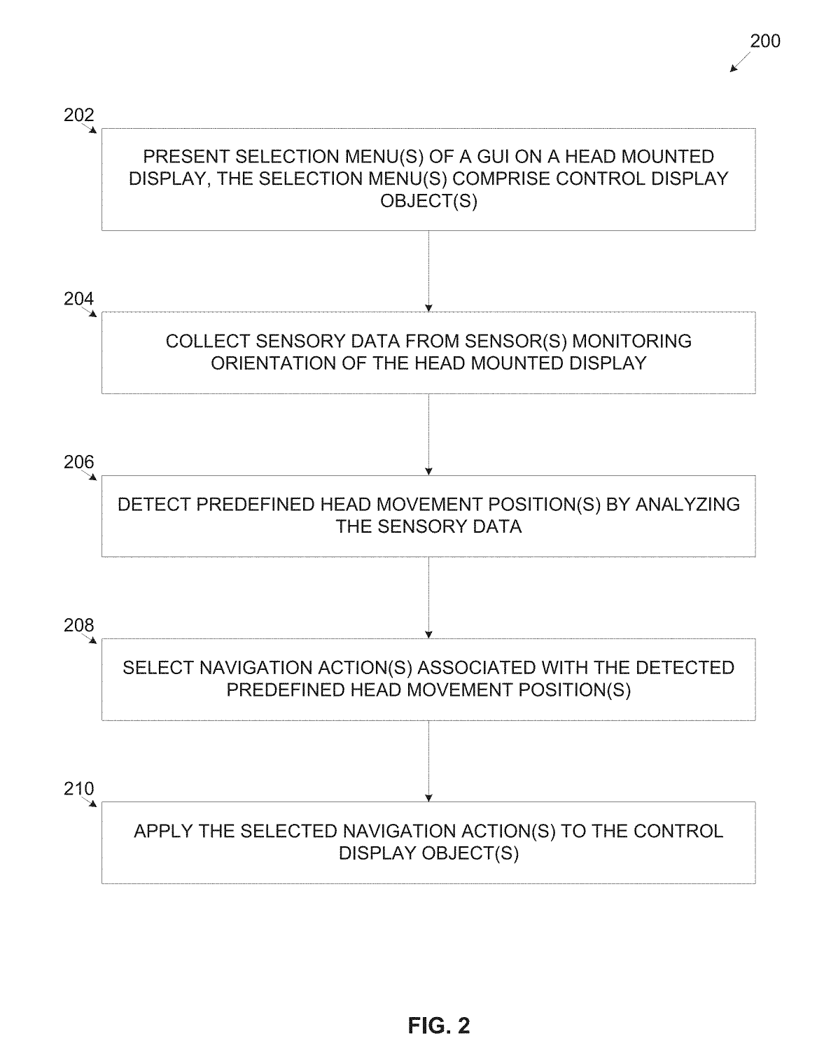

Reference is also made to FIG. 2, which is a flowchart of controlling a menu based AR GUI according to predefined head movement positions, according to some embodiments of the present invention. An exemplary process 200 may be executed by the AR display manager 110 in the system 100 to control the AR display presented by the head mount display 122. In particular, the process 200 may be executed to control a menu based GUI of the AR display according to predefined discrete head movement positions of the head mount 120 which may be induced by a user using (wearing) the head mount 120.

As shown at 202, the AR display manager 110 generates a GUI displayed in the AR presentation space (ARPS) of the AR display presented by the head mount display 120. The AR display manager 110 may generate a plurality of GUI pages presented in the AR display. Each GUI page may include one or more selection menus, for example, a toolbar, a list, a table and/or the like, where each of the selection menus may comprise one or more control display objects. Each of control display objects may be associated with one or more actions, operations, tools and/or the like. For example, one or more of the control display objects may be associated with a navigation action for navigating through the selection menu(s). In another example, one or more of the control display objects may be associated with one or more application functions of one or more application(s) executed by the processor(s) 104. Optionally, one or more of the control display objects may further be associated with one or more application functions executed by one or more other devices, for example, a Smartphone, a tablet, a Smart watch and/or the like which are coupled to the AR display controller 101 through the network(s) 150. For example, one or more of the control display objects may be associated with initiating a phone call through the Smartphone coupled to the AR display controller 101. The AR display controller 101 may further synchronize with the Smartphone, for example, to retrieve a contacts list from the Smartphone in order to present the contact list and/or part thereof on the AR display. One or more of the selection menu(s) presented by the AR display manager 110 may be constructed to have a single row, column and/or axis of control display objects such that back and/or forth scrolling, advancing and/or navigating through the control display objects may be done in a single direction (axis), for example, up/down, right/left, clockwise/counterclockwise and/or the like.

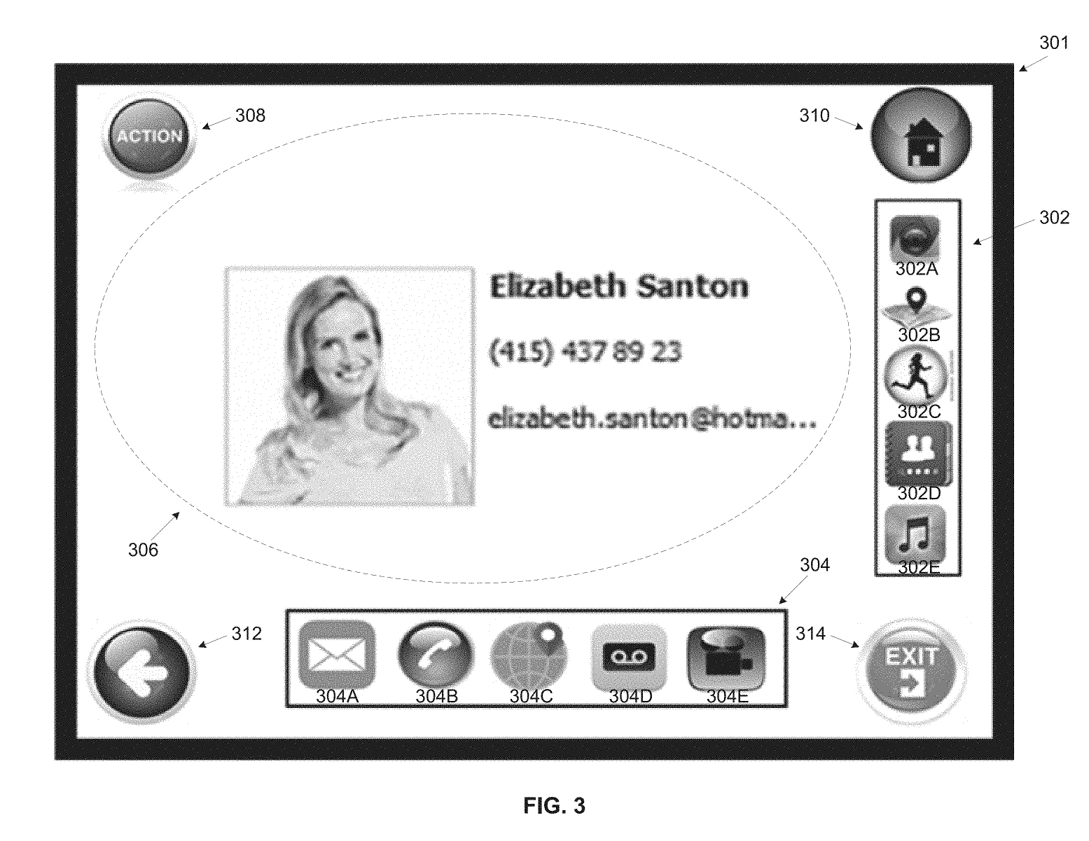

Reference is now made to FIG. 3, which is a schematic illustration of an exemplary GUI of an AR display, according to some embodiments of the present invention. An exemplary AR display presentation 301 may include one or more selection menus, for example, a vertical selection menu 302, a horizontal selection menu 304, a radial selection menu and/or the like. The vertical selection menu 302 may include one or more control display objects, for example, control display objects 302A, 302B, 302C, 302D and/or 302E. The horizontal selection menu 304 may include one or more control display objects, for example, control display objects 304A, 304B, 304C, 304D and/or 304E. One or more of the control display objects 302A-302E and/or 304A-304E may be associated with one or more tools, navigation actions, application functions and/or the like.

In some embodiments, one or more of the selection menus may be selection sub-menus to other selection menus which are considered as the parent selection menu for the respective selection sub-menu. In such case, selecting a certain control display object in the parent selection menu may open and/or populate a respective selection sub-menu which may typically include control display object relating to the certain control display object selected in the parent selection menu. For example, the horizontal selection menu 304 may be a selection sub-menu of the vertical selection menu 302. In such case, the control display objects 304A-304E may relate to a certain control display object in the vertical selection menu 302, for example, the control display object 302D.

The GUI may further include a global selection menu which may be presented in the AR display regardless of which GUI page is currently presented and/or regardless of which selection menu is currently used, navigated, selected and/or the like. The global selection menu may be presented, for example, at the corners of the AR display and may include one or more control display objects, for example, control display objects 308, 310, 312C and/or 314. The control display objects 308, 310, 312C and/or 314 may be associated for example, with general actions, operations and/or application functions that may be selected during a plurality of presentation screens presented in the AR display. For example, the control display object 308 may be associated with confirmation to execute the action associated with the control display object currently selected. In another example, the control display object 310 may be associated with an action to return to an initial page of the GUI presentation, i.e. reset the GUI presentation to its initial settings. In another example, the control display object 312 may be associated with an action to return to a previous (parent) selection menu of the GUI. In another example, the control display object 314 may be associated with an action to quit (exit) the GUI presentation, for example, disable activity of the selection menu(s), remove the selection menu(s) from the AR display, remove the GUI from the AR display, turn off the head mount display 120 and/or the like.

The AR display may also include central display region 306 in which the AR display manager 110 may present additional information, for example, one or more additional selection menus, actionable information, descriptive information and/or the like. For example, the AR display manager 110 may present one or more selection menus which may selection sub-menus presenting optional operations relating to one or more of the control display objects in the vertical selection menu 302 and/or the horizontal selection menu 304. For example, a certain one of the control display objects in the horizontal selection menu 304 may be associated with a certain child selection sub-menu comprising one or more control display objects. Selection of the certain control display object may initiate presentation of the certain child selection sub-menu. For example, assuming the control display object 304B which is associated with an application function for initiating a phone call a is selected, the AR display manager 110 may present a contacts list in the central display region 306 to allow selection of the contact to which the phone call is to be directed. Furthermore, assuming one of the contacts in the contact list is selected, the AR display manager 110 may present a description of the selected contact person in the central display region 306.

Reference is made once again to FIG. 2.

As shown at 204, the AR display manager 110 obtains, collects and/or receives sensory data from the orientation sensor(s) 130 which monitor the orientation, movement and/or position of the head mount 120.

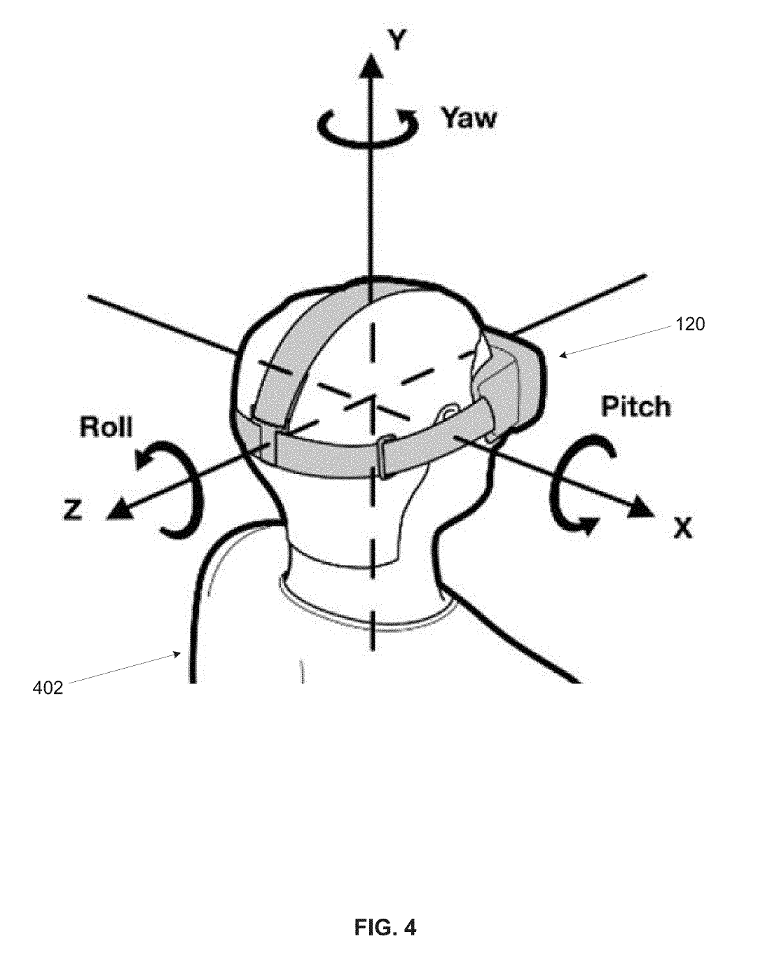

Reference is now made to FIG. 4, which is a schematic illustration of an exemplary head mount display. A user 402 may use (wear) a head mount such as the head mount 120 and view an AR display presented by a head mount display such as the head mount display 122. One or more orientation sensor 130 such as the orientation sensor 130 may monitor orientation, movement and/or position of the head mount 120. For example, the orientation sensor(s) 130 may capture yaw, pitch and/or roll movements of the head mount 120 which may be induced by the user 402 wearing the head mount 120 and moving his head. As discussed before, typically the orientation sensor(s) 130 are integrated, attached and/or coupled to the head mount 120.

Reference is made once again to FIG. 2.

As shown at 206, the AR display manager 110 may calculate one or more head movement positions of the head mount 120 by analyzing the sensory data obtained from the orientation sensor(s) 130.

As shown at 208, the AR display manager 110 may compare the calculated head movement position(s) to one or more predefined discrete head movement positions to detect a match between the calculated head movement position(s) and the predefined discrete head movement position(s). The predefined discrete head movement positions may be predefined and stored in a predefined discrete head movement positions record such as the predefined discrete head movement positions record 112. Each of the predefined discrete head movement position may define a movement vector in a single direction to a position in a 3-dimension (3D) space of the head mount 120. The single direction movement vector may be a movement from one position to an adjacent position, i.e. each predefined discrete head movement position defines a discrete movement to a new adjacent position in the 3D space. For each predefined discrete head movement position, the predefined discrete head movement positions record 112 may include absolute and/or relational positioning information corresponding to the respective predefined discrete head movement position.

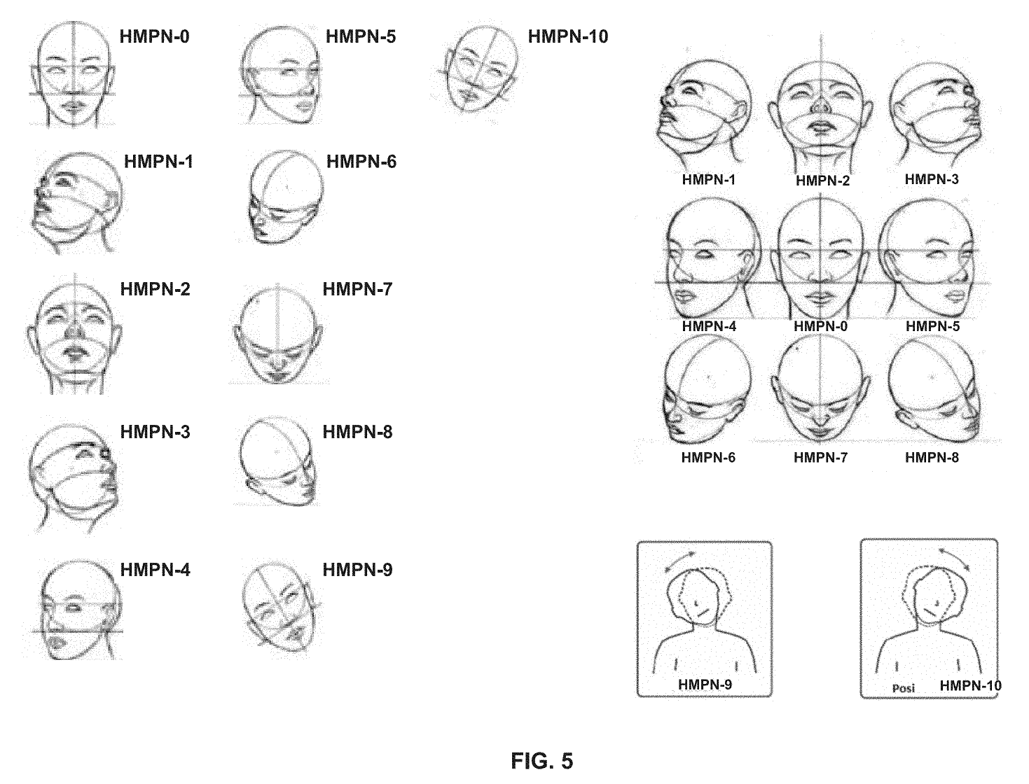

Reference is now made to FIG. 5, which is a schematic illustration of an exemplary set of predefined head movement positions, according to some embodiments of the present invention. An exemplary set of predefined discrete head movement positions may include a plurality of predefined discrete head movement position (HMPN), for example, HMPN-0, HMPN-1, HMPN-2, HMPN-3, HMPN-3, HMPN-5, HMPN-6, HMPN-7, HMPN-8, HMPN-9 and/or HMPN-10. The predefined discrete head movement position may typically be natural human head movements in the 3D space, for example, lowering, raising, tilting, oscillating, rotating, pointing and/or a combination thereof. For example, the HMPN-0 defines a position in the 3D space which may serve as a reference position, an idle position and/or a starting position in which the head mount 120 is centered in the 3D space. The HMPN-1 may define a point movement up and to the right. The HMPN-2 may define a raising movement. The HMPN-3 may define a point movement up and to the left. The HMPN-4 may define a rotation movement to the right. The HMPN-4 may define a rotation movement to the left. The HMPN-6 may define a point movement down and to the right. The HMPN-7 may define a lowering movement. The HMPN-8 may define a point movement down and to the left. The HMPN-9 may define a tilt movement to the right. The HMPN-10 may define a tilt movement to the left.

Reference is made once again to FIG. 2.

Optionally, the AR display manager 110 calibrates an orientation reference for the head mount 120 by presenting a calibration GUI to a user such as the user 402. By calibrating the orientation reference for the head mount 120, the AR display manager 110 may improve determination of the orientation, position and/or movement of the head mount 120 to improve detection of the pre-defined discrete head movement positions. Moreover, through the calibration sequence, the AR display manager 110 may adapt to head movement positions as performed by the specific user 402.

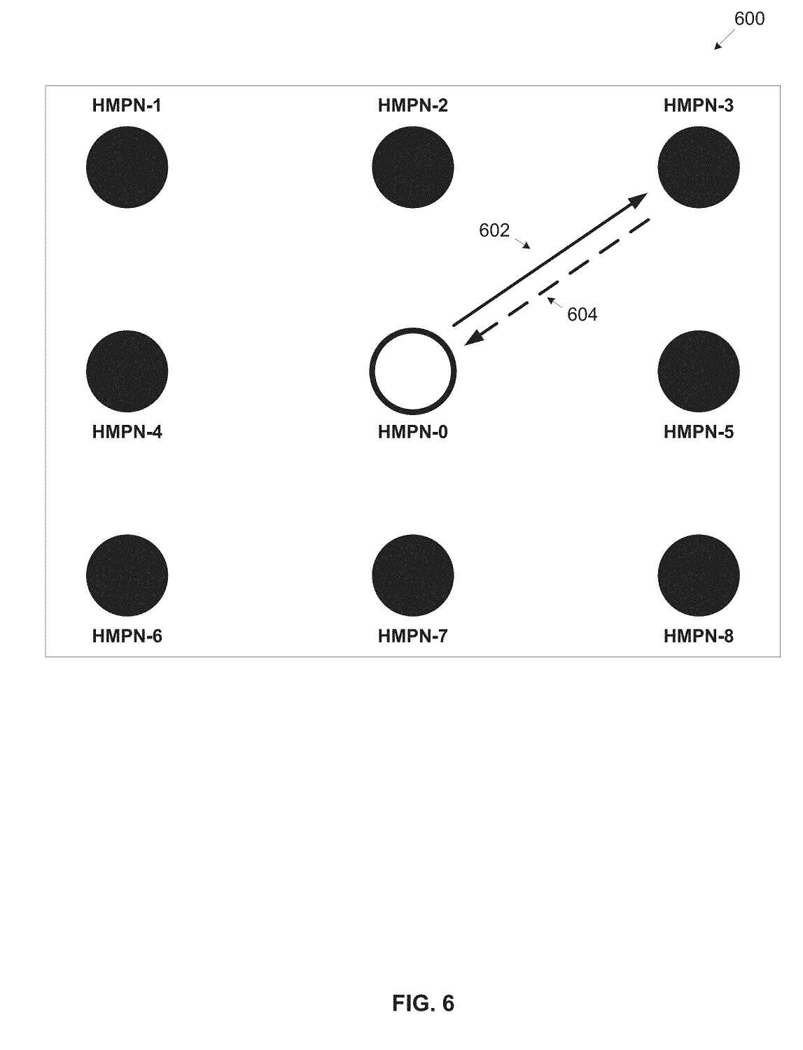

Reference is now made to FIG. 6, which is a schematic illustration of an exemplary calibration GUI for calibrating a head mount display, according to some embodiments of the present invention. An exemplary calibration GUI 600 may be presented by an AR display manager such as the AR display manager 110 to a user such as the user 402 using a head mount such as the head mount 120. The AR display manager 110 may control a head mount display such as head mount display 122 to present the calibration GUI 600 which may include, for example, 9 positions corresponding to one or more of the predefined discrete head movement position, for example, the HMPN-0 through HMPN-8. The AR display manager 110 may further instruct the user 420, for example, by presenting one or more direction lines to move his head from one indicated predefined discrete head movement position to another. For example, the AR display manager 110 may present the solid arrowed line 602 to instruct the user 402 to move his head from the HMPN-0 to the HMPN-3. The AR display manager 110 may then present the dashed arrowed line 604 to instruct the user 402 to move his head back to from the HMPN-3 to the HMPN-0. The AR display manager 110 may repeat the calibration process to instruct the user 402 to move through additional predefined discrete head movement positions.

Reference is made once again to FIG. 2.

Optionally, the AR display manager 110 employs one or more machine learning mechanisms to adjust and/or calibrate one or more of the predefined discrete head positions according to head movements of one or more users such as the user 402. By learning the head movement positions of a plurality of user, the predefined discrete head positions may be adjusted to better simulate actual head movement positions as performed by the users 420. The AR display manager 110 may thus improve matching of the calculated head movement position(s) of the head mount 120 to the adjusted predefined discrete head movement positions and may therefore improve accuracy of the detection of the predefined discrete head movement positions.

Moreover, the AR display manager 110 may employ one or more of the machine learning mechanisms to learn and identify head movement patterns of a specific user 402 during a plurality of sessions in which the user 420 uses the head mount 120. Since naturally each user 402 may perform the head movements differently than other users 402, the AR display manager 110 may identify head movement patterns associated with the specific user 402 and may adjust the predefined discrete head movement positions accordingly. This may also improve matching of the calculated head movement position(s) of the head mount 120 to the adjusted predefined discrete head movement positions and may therefore improve accuracy of the detection of the predefined discrete head movement positions.

As shown at 208, the AR display manager 110 may select one or more navigation actions mapped by the detected predefined discrete head movement position(s).

Each of the predefined discrete head movement positions may map a navigation action, for example, move left, move right, move up, move down, move diagonally up, move diagonally down, move clockwise, move counterclockwise, move inwards, move outwards, select, confirm selection, initiate an application function, return to a previous selection menu and/or the like. In practice, each of the navigation actions is mapped by a sequence of movement between two of the predefined discrete head movement positions, typically from the reference position to one of the predefined discrete head movement positions and back to the reference position. For example, sequence of movement between two of the predefined discrete head movement positions may be from the HMPN-0 to one of the other HMPNs and back to the HMPN-0. The mapping may employ natural intuitive logic, for example, the HMPN-2 defining a raising predefined discrete head movement position may map the move up navigation action. In another example, the HMPN-7 defining a lowering predefined discrete head movement position may map the move down navigation action.

One or more of the predefined discrete head movement positions may map multiple different navigation actions in different contexts. For example, a certain predefined discrete head movement position may map a move up navigation action while navigating through a first selection menu and the same certain predefined discrete head movement position may map a selection confirmation while navigating through a second selection menu

Optionally, the AR display manager 110 calibrates a reference for the head mount 120 according to the predefined discrete head movement positions detected during the navigation sequence through the GUI presented by the AR display manager 110. By detecting the matching predefined discrete head movement positions, the AR display manager 110 may estimate a current orientation of the head mount 120 to improve orientation reference synchronization with the head mount 120.

As shown at 210, the AR display manager 110 applies the selected navigation action(s) mapped by the detected predefined discrete head movement position(s) to the currently selected control display object to navigate through the presented GUI, initiate one or more action, operations and/or application functions and/or the like. The AR display manager 110 applies the selected navigation action in a discrete manner, i.e. each detected predefined discrete head movement position initiates a single navigation action.

Optionally, a minimum time threshold, for example, 1 second and/or the like may be set to define the minimum time duration during which the head mount 120 needs to maintain the detected predefined discrete head movement position before returning to the reference discrete head movement position in order for the AR display manager 110 to detect the predefined discrete head movement position as a valid one.

Optionally, the AR display manager 110 supports rapid navigation by applying the navigation action mapped by the detected predefined discrete head movement position with relation to the time duration in which the detected predefined head movement position is maintained. A navigation action time unit may be set, for example, 1 second and/or the like to define a repetition of the navigation action mapped by the detected predefined head movement position in case the head mount 120 maintains the detected predefined discrete head movement position for an extended time duration before returning to the reference discrete head movement position. For example, assuming the AR display manager 110 detects that a certain predefined discrete head movement is detected continuously for 3 seconds, the AR display manager 110 may repeat three times the navigation action mapped by the detected certain predefined head movement position.

Optionally, the AR display manager 110 enables and disables the functionality of one or more of the control display objects and/or of one or more of the selection menus based on an analysis of activity sensory data received from one or more activity sensors such as the activity sensor 140. Optionally, the AR display manager 110 may obtain the activity sensory data from one or more connected devices, for example, a Smartphone, a Smart watch, a tracking device and/or the like which are connected to the AR controller 101 through the I/O interface 102. Analyzing the received sensory data, the AR display manager 110 may determine that the user 402 may be engaged in an activity that may prevent him from properly controlling and/or navigating through the GUI by manipulating the orientation of the head mount 120 to simulate the predefined discrete head movement positions. For example, the user 402 may be engaged in a sport activity, for example, biking, skiing, running, gliding and/or the like. The AR display manager 110 may analyze the sensory data, for example, a speed, an altitude, and altitude change, a geographical location and/or the like to determine whether the user 402 is engaged in the activity and enable or disable the GUI and/or part thereof according to the determination. For example, based on the sensory data analysis, the AR display manager 110 may determine that the user 402 is in a ski resort, ascending slowly and may therefore assume the user 402 is riding a ski lift. In such case the AR display manager 110 may enable the GUI and/or part thereof, for example, enable one or more selection menus, enable one or more control display objects and/or the like. In another example, based on the sensory data analysis, the AR display manager 110 may determine that the user 402 is in a ski resort, descending fast and may therefore assume the user 402 is skiing downhill. In such case the AR display manager 110 may disable the GUI and/or part thereof, for example, disable one or more selection menus, disable one or more control display objects and/or the like

The process 200 executed by the AR display manager 110 may be illustrated through several examples for navigating through exemplary GUI presentation pages.

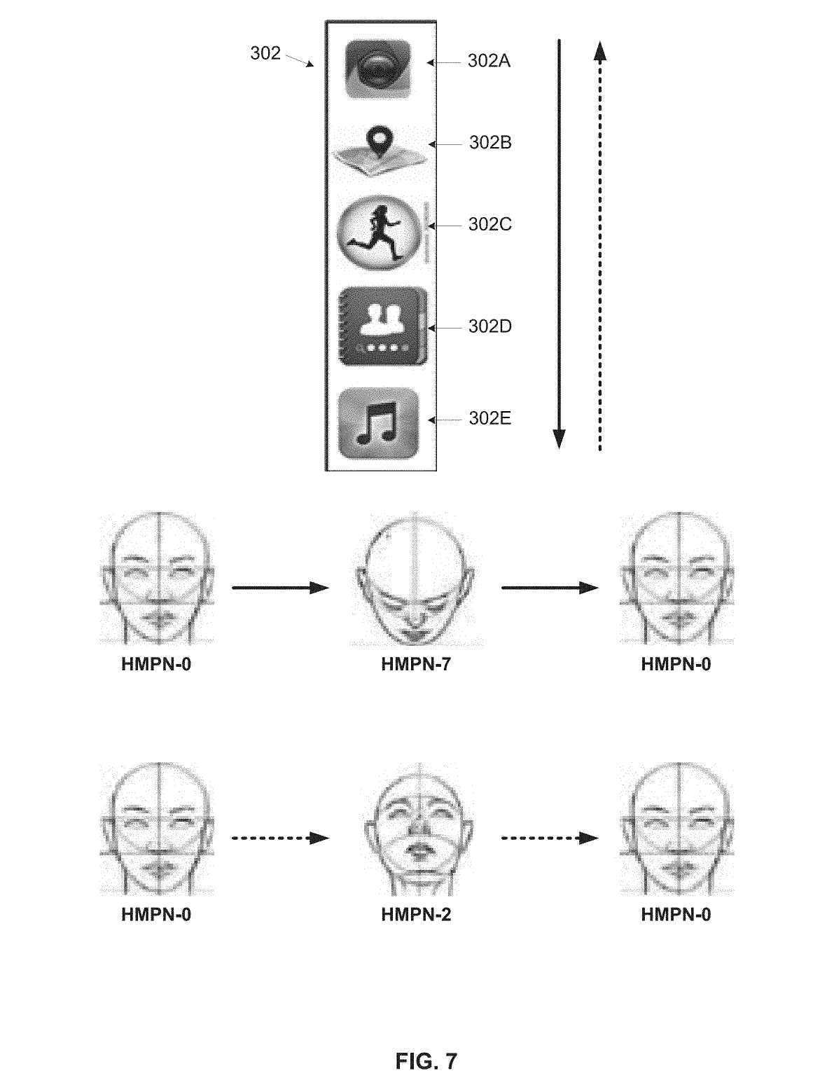

Reference is now made to FIG. 7, which is a schematic illustration of exemplary sequences for navigating through an exemplary vertical selection menu of a GUI of an AR display, according to some embodiments of the present invention. An exemplary vertical selection menu such as the vertical selection menu 302 of a GUI generated by an AR display manager such as the AR display manager 110 may be presented in head mount display such as the head mount display 122 of a head mount such as the head mount 120. The vertical selection menu 302 may include control display objects 302A, 302B, 302C, 302D and/or 302E. One or more of the predefined discrete head movement positions may map one or more navigation actions through the vertical selection menu 302. For example, the predefined discrete head movement position HMPN-7 may map a move down navigation action and the predefined discrete head movement position HMPN-2 may map a move up navigation action. For example, assuming the control display object 302B is currently pointed, i.e. the most recent navigation action taken by the AR display manager 110 was moving to the control display object 302B. In case the AR display manager 110 detects a match of the head mount 120 orientation to the predefined discrete head movement position HMPN-7 (i.e. move from HMPN-0 to HMPN-7 and back to HMPN-0), the AR display manager 110 moves the pointer down to point to the control display object 302C. In case the AR display manager 110 detects a match of the head mount 120 orientation to the predefined discrete head movement position HMPN-2 (i.e. move from HMPN-0 to HMPN-2 and back to HMPN-0), the AR display manager 110 moves the pointer up to point to the control display object 302A. One or more predefined discrete head movement positions may map selection confirmation of the action, operation and/or application function associated with the pointed control display object. For example, the predefined discrete head movement positions HMPN-4 (i.e. move from HMPN-0 to HMPN-4 and back to HMPN-0) and/or HMPN-5 (i.e. move from HMPN-0 to HMPN-5 and back to HMPN-0) may map the selection confirmation for the control display objects of the vertical selection menu 302.

As discussed before, the AR display manager 110 may apply rapid navigation for continuously scrolling through the vertical selection menu 302 according to a length of the time duration in which the orientation of the head mount 120 is detected to be in one of the predefined discrete head movement positions. For example, assuming, the navigation action time unit is set to 1 second and the AR display manager 110 currently points at the control display object 302B. In case the AR display manager 110 detects that the head mount 120 orientation matches the predefined discrete head movement position HMPN-7 (i.e. move from HMPN-0 to HMPN-7) and the orientation is maintained at HMPN-7 for 3 seconds, the AR display manager 110 may apply the move down navigation action 3 times to scroll down to the control display object 302E.

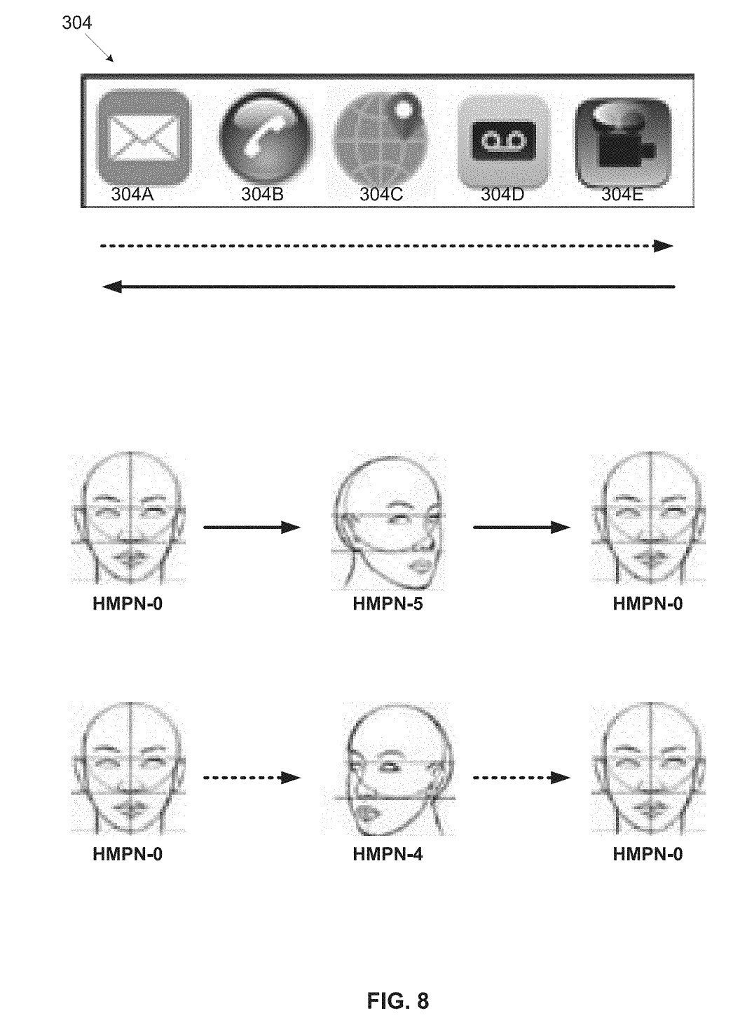

Reference is now made to FIG. 8, which is a schematic illustration of exemplary sequences for navigating through an exemplary horizontal selection menu of a GUI of an AR display, according to some embodiments of the present invention. An exemplary horizontal selection menu such as the horizontal selection menu 304 of a GUI generated by an AR display manager such as the AR display manager 110 may be presented in head mount display such as the head mount display 122 of a head mount such as the head mount 120. The horizontal selection menu 304 may include control display objects 304A, 304B, 304C, 304D and/or 304E. One or more of the predefined discrete head movement positions may map one or more navigation actions through the horizontal selection menu 304. For example, the predefined discrete head movement position HMPN-5 may map a move left navigation action and the predefined discrete head movement position HMPN-4 may map a move right navigation action. For example, assuming the control display object 304C is currently pointed, i.e. the most recent navigation action taken by the AR display manager 110 was moving to the control display object 304C. In case the AR display manager 110 detects a match of the head mount 120 orientation to the predefined discrete head movement position HMPN-5 (i.e. move from HMPN-0 to HMPN-5 and back to HMPN-0), the AR display manager 110 moves the pointer left to point to the control display object 304A. In case the AR display manager 110 detects a match of the head mount 120 orientation to the predefined discrete head movement position HMPN-4 (i.e. move from HMPN-0 to HMPN-4 and back to HMPN-0), the AR display manager 110 moves the pointer right to point to the control display object 304D. One or more predefined discrete head movement positions may map selection confirmation of the action, operation and/or application function associated with the pointed control display object. For example, the predefined discrete head movement positions HMPN-2 (i.e. move from HMPN-0 to HMPN-2 and back to HMPN-0) and/or HMPN-7 (i.e. move from HMPN-0 to HMPN-7 and back to HMPN-0) may map the selection confirmation for the control display objects of the horizontal selection menu 304.

Similarly to the previous example and as discussed before, the AR display manager 110 may apply rapid navigation for continuously scrolling through the horizontal selection menu 304 according to a length of the time duration in which the orientation of the head mount 120 is detected to be in one of the predefined discrete head movement positions. For example, assuming, the navigation action time unit is set to 1 second and the AR display manager 110 currently points at the control display object 304A. In case the AR display manager 110 detects that the head mount 120 orientation matches the predefined discrete head movement position HMPN-4 (i.e. move from HMPN-0 to HMPN-4) and the orientation is maintained at HMPN-4 for 3 seconds, the AR display manager 110 may apply the move down navigation action 3 times to scroll left to the control display object 304D.

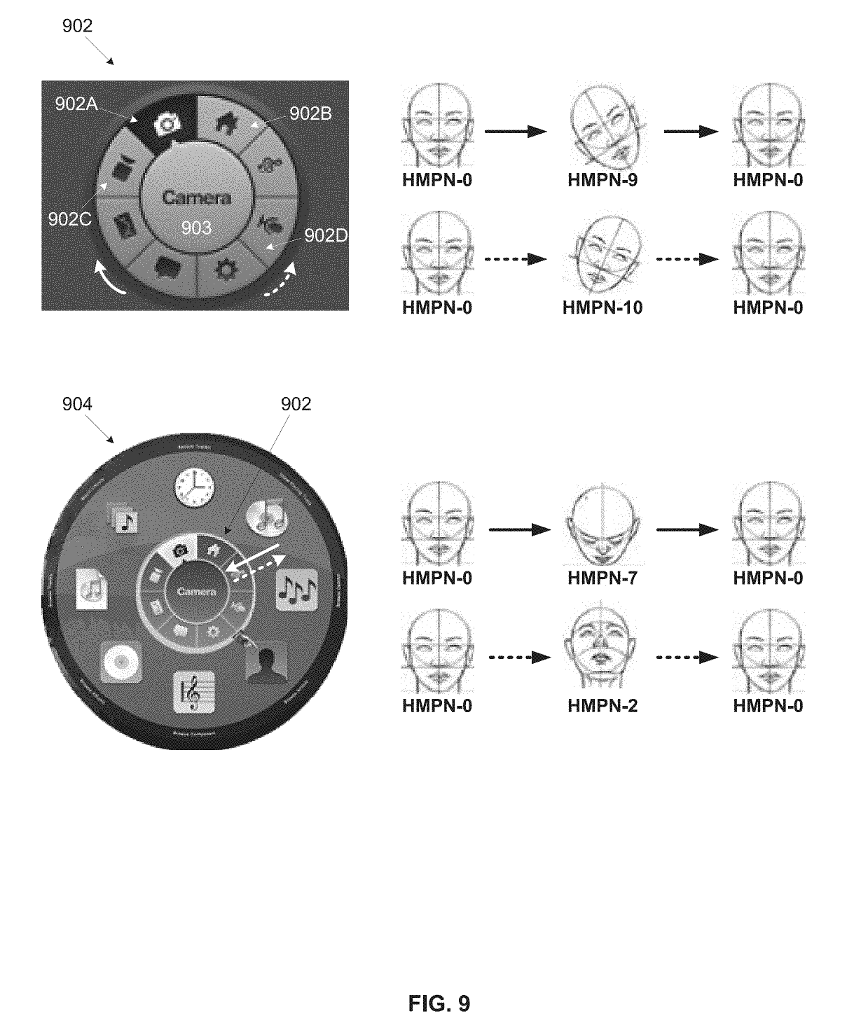

Reference is now made to FIG. 9, which is a schematic illustration of exemplary sequences for navigating through an exemplary radial selection menu of a GUI of an AR display, according to some embodiments of the present invention. An exemplary radial selection menu 902 of a GUI generated by an AR display manager such as the AR display manager 110 may be presented in head mount display such as the head mount display 122 of a head mount such as the head mount 120. The radial selection menu 902 may include one or more control display objects arranged in a circle around an exemplary dial 903. One or more of the predefined discrete head movement positions may map one or more navigation actions through the radial selection menu 902. For example, the predefined discrete head movement position HMPN-9 may map a clockwise navigation action and the predefined discrete head movement position HMPN-10 may map a counterclockwise navigation action. For example, assuming the dial 903 is currently pointing to a control display object 902A. In case the AR display manager 110 detects a match of the head mount 120 orientation to the predefined discrete head movement position HMPN-9 (i.e. move from HMPN-0 to HMPN-9 and back to HMPN-0), the AR display manager 110 moves the dial 903 clockwise to point to the control display object 902B. In case the AR display manager 110 detects a match of the head mount 120 orientation to the predefined discrete head movement position HMPN-10 (i.e. move from HMPN-0 to HMPN-10 and back to HMPN-0), the AR display manager 110 moves counter clockwise the dial 903 to point to the control display object 902C. One or more predefined discrete head movement positions may map selection confirmation of the action, operation and/or application function associated with the pointed control display object. For example, the predefined discrete head movement positions HMPN-4 (i.e. move from HMPN-0 to HMPN-4 and back to HMPN-0) and/or HMPN-5 (i.e. move from HMPN-0 to HMPN-5 and back to HMPN-0) may map the selection confirmation for the control display objects of the radial selection menu 902.

Similarly to the previous examples and as discussed before, the AR display manager 110 may apply rapid navigation for continuously scrolling through the radial selection menu 902 according to a length of the time duration in which the orientation of the head mount 120 is detected to be in one of the predefined discrete head movement positions. For example, assuming, the navigation action time unit is set to 1 second and the dial 903 currently points at the control display object 902A. In case the AR display manager 110 detects that the head mount 120 orientation matches the predefined discrete head movement position HMPN-9 (i.e. move from HMPN-0 to HMPN-9) and the orientation is maintained at HMPN-9 for 3 seconds, the AR display manager 110 may apply the move clockwise navigation action 3 times to move the dial 903 clockwise point to the control display object 902D.

One or more of the control display objects of the radial selection menu 902 may be associated with a sub-menu, for example, a radial selection sub-menu 904. Navigation and selection confirmation through the radial selection sub-menu 904 may be utilized similarly to the navigation through the parent radial selection menu 902. One or more of the predefined discrete head movement positions may map one or more navigation actions for moving inwards and/or outwards between the radial selection menu 902 and the radial selection sub-menu 904. For example, the predefined discrete head movement position HMPN-2 may map a move outwards from the radial selection menu 902 to the radial selection sub-menu 904. The predefined discrete head movement position HMPN-7 may map a move inwards from the radial selection sub-menu 904 to the radial selection menu 902.

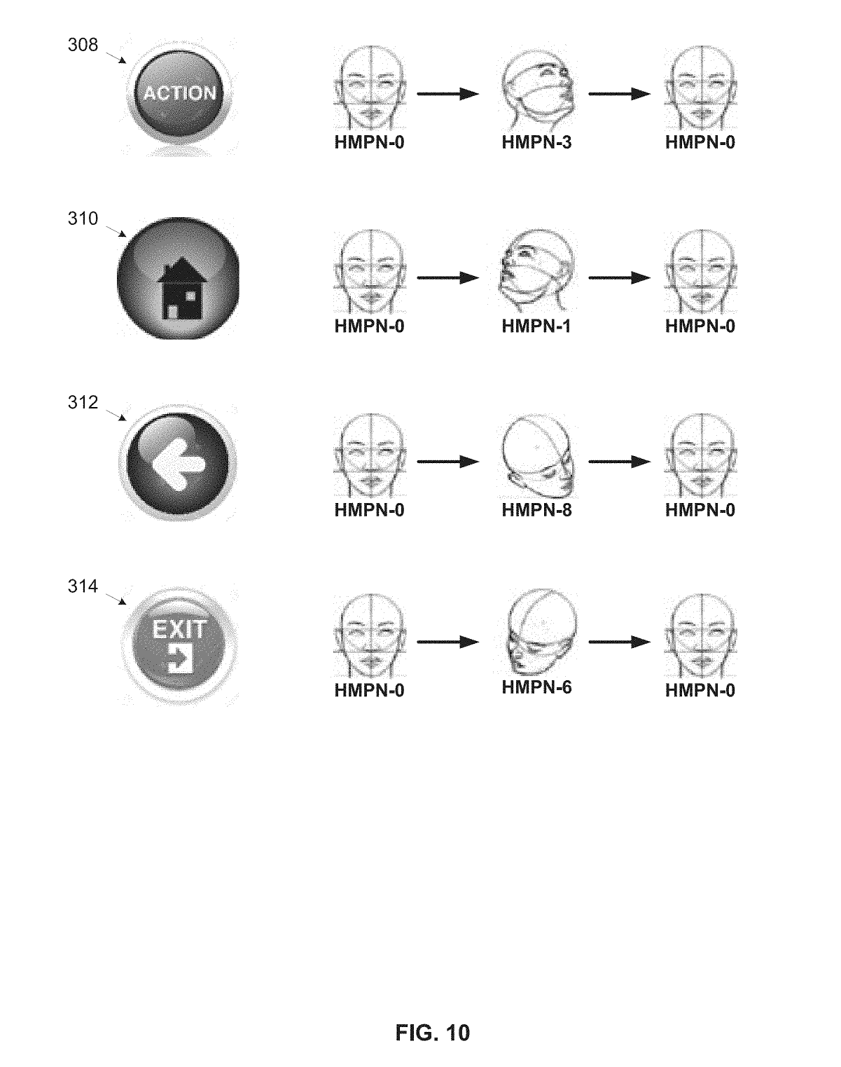

Reference is now made to FIG. 10, which is a schematic illustration of exemplary sequences for navigating through an exemplary global selection menu of a GUI of an AR display, according to some embodiments of the present invention. Exemplary control display objects such as the control display objects 308, 310, 312 and/or 314 of a GUI generated by an AR display manager such as the AR display manager 110 may be presented in head mount display such as the head mount display 122 of a head mount such as the head mount 120. One or more of the predefined discrete head movement positions may map one or more navigation actions to navigate to (select) the control display objects 308, 310, 312 and/or 314. For example, the predefined discrete head movement position HMPN-3 may map a move to top left corner navigation action, the predefined discrete head movement position HMPN-1 may map a move to top right corner navigation action, the predefined discrete head movement position HMPN-8 may map a move to bottom left corner navigation action and/or the predefined discrete head movement position HMPN-6 may map a move to bottom right corner navigation action. When detecting one of the control display objects 308, 310, 312 and/or 314, the AR display manager 110 may navigate to the mapped control display objects 308, 310, 312 and/or 314 regardless of which selection menu and/or control display object is currently pointed (selected).

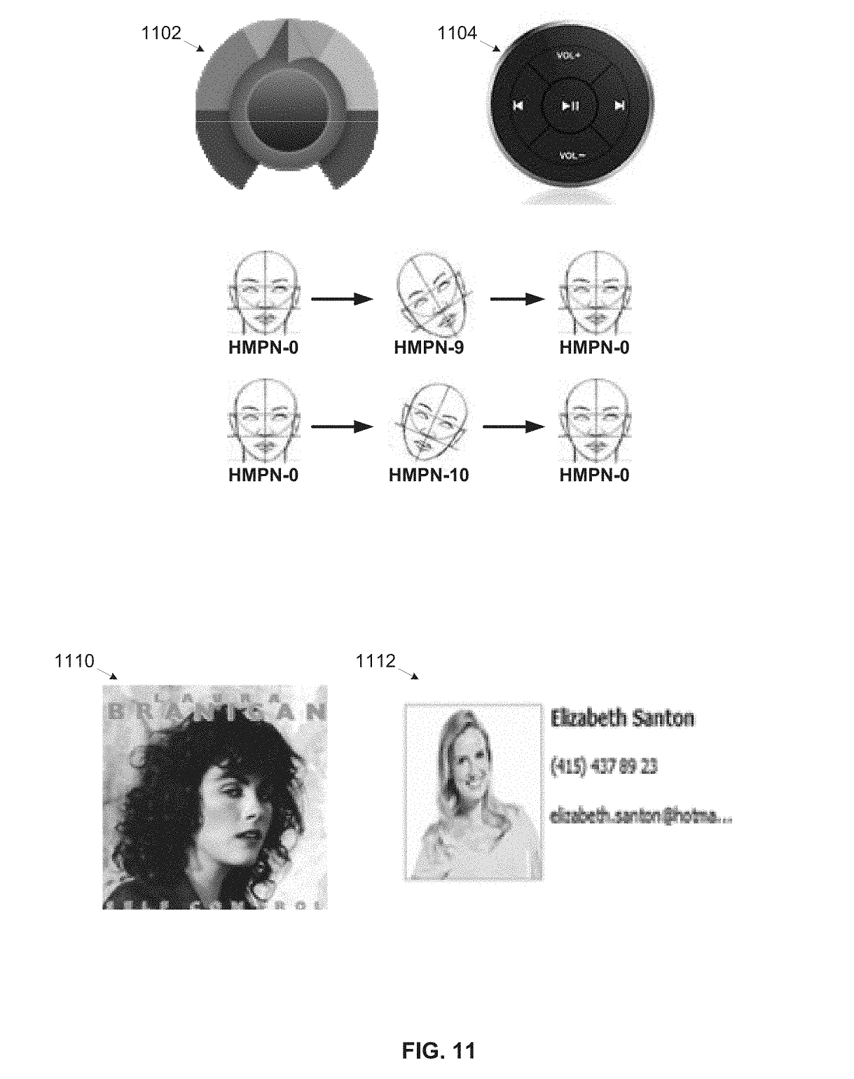

Reference is now made to FIG. 11, which is a schematic illustration of exemplary main display area presentations, according to some embodiments of the present invention. As described herein before, an AR display manager such as the AR display manager 110 may presented one or more additional information items in a central display region such as the central display region 306 displayed by a head mount display such as the head mount display 122 of a head mount such as the head mount 120. The one or more additional information items may include, for example, an additional selection menu, an actionable information item, a descriptive information item and/or the like.

For example, in response to selection of a certain one of the control display objects of one or more of the selection menus, the AR display manager 110 may presented an exemplary radial color selection menu 1102 and/or an exemplary radial music/video control selection menu 1104 which relate to the selected certain control display object. For example, assuming a music control display object is selected in one of the selection menus of the GUI generated by the AR display manager 110, the AR display manager 110 may present the radial music/video control selection menu 1104 in the central display region 306. Navigating through the radial selection menus 1102 and/or 1104 may be done, for example, as described for the radial selection menu 902. For example, in case the AR display manager 110 detects a match of the head mount 120 orientation to the predefined discrete head movement position HMPN-9 (i.e. move from HMPN-0 to HMPN-9 and back to HMPN-0), the AR display manager 110 may select the next control display object in clockwise direction from the currently selected control display object. In case the AR display manager 110 detects a match of the head mount 120 orientation to the predefined discrete head movement position HMPN-10 (i.e. move from HMPN-0 to HMPN-10 and back to HMPN-0), the AR display manager 110 may select the next control display object in counterclockwise direction from the currently selected control display object. One or more predefined discrete head movement positions may map selection confirmation of the action, operation and/or application function associated with the pointed control display object. For example, the predefined discrete head movement positions HMPN-4 (i.e. move from HMPN-0 to HMPN-4 and back to HMPN-0) and/or HMPN-5 (i.e. move from HMPN-0 to HMPN-5 and back to HMPN-0) may map the selection confirmation for the control display objects of the radial selection menu 1102 and/or 1104.

Optionally, the AR display manager 110 may present one or more descriptive and/or actionable information items in the central display region 306, for example, a music album cover 1110 and/or a contact information card 1112. For example, assuming a music soundtrack is selected in a music player control display object in one of the selection menus of the GUI generated by the AR display manager 110, the AR display manager 110 may present the music album cover 1110 of the selected music soundtrack. In another example, assuming a contact person is selected from a contacts control display object in one of the selection menus of the GUI generated by the AR display manager 110, the AR display manager 110 may present the contact information card 1112 of the selected contact person.

It is expected that during the life of a patent maturing from this application many relevant technologies and/or methodologies will be developed and the scope of the terms client terminal and head mount are intended to include all such new technologies a priori.

As used herein the term “about” refers to ±10%.

The terms “comprises”, “comprising”, “includes”, “including”, “having” and their conjugates mean “including but not limited to”.

The term “consisting of” means “including and limited to”.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

What is claimed is:

1. A system for controlling a menu based augmented reality (AR) Graphical User Interface (GUI) according to predefined head movement positions, comprising:
a head mounted AR display; and
at least one hardware processor adapted to execute a code, said code comprising:
code instructions to present at least one selection menu of a GUI displayed by said head mounted AR display, said at least one selection menu comprising at least one of a plurality of control display objects,
code instructions to detect at least one of a plurality of predefined discrete head movement positions of said head mounted display by analyzing sensory data received from at least one orientation sensor monitoring orientation of said head mounted display, each of said plurality of predefined discrete head movement positions maps one of a plurality of navigation actions, and
code instructions to apply a respective navigation action mapped by said at least one detected predefined discrete head movement position on a currently pointed control object of said plurality of control display objects.

2. The system of claim 1, wherein said at least one orientation sensor is a member of a group consisting of: an accelerometer, a gyroscope, a Global Positioning System (GPS) sensor and an altitude sensor.

3. The system of claim 1, wherein said at least one orientation sensor is integrated in said head mounted display.

4. The system of claim 1, wherein said at least one processor is integrated in said head mounted display.

5. The system of claim 1, wherein each of said plurality of predefined discrete head movement positions defines a movement vector in a single direction from a reference position to a position in a 3-dimension (3D) space of said head mounted display.

6. The system of claim 1, wherein said navigation action is a member of a group consisting of: move left, move right, move up, move down, move diagonally up, move diagonally down, move clockwise, move counterclockwise, move inwards, move outwards, select, confirm selection, initiate an application function and return to a previous selection menu.

7. The system of claim 1, wherein said code further comprising code instructions to present at least one selection sub-menu on said AR display in response to selection of said at least one control display object.

8. The system of claim 1, wherein said at least one selection menu is scrollable back and forth along a single axis.

9. The system of claim 1, wherein at least one of said plurality of control display objects is associated with one of a plurality of application functions of at least one application, said code comprising code instructions to execute a respective application function associated with said at least one control display object in response to selection confirmation of said at least one control display object.

10. The system of claim 1, wherein said code further comprising code instructions to navigate rapidly by repeating at least one of said plurality of navigation actions is repeated according to a time interval during which said head mounted display is maintained in a respective one of said plurality of predefined discrete head movement positions mapping said at least one navigation action.

11. The system of claim 1, wherein said code further comprising code instructions to calibrate said at least one orientation sensor according to at least one of said plurality of predefined discrete head movement positions of said head mounted display during a calibration session.

12. The system of claim 1, wherein said code further comprising code instructions to calibrate said at least one orientation sensor according to said at least one predefined discrete head movement position of said head mounted display while navigating through said at least one selection menu.

13. The system of claim 1, wherein said code further comprising code instructions to disable at least some of said plurality of navigation actions based on analysis of sensory data received from at least one activity sensor, said at least one activity sensor is a member of a group consisting of: said at least one orientation sensor, a GPS sensor and an altitude sensor.

14. The system of claim 1, wherein said code further comprising code instructions to use at least one machine learning algorithm to correlate at least one head movement position pattern of at least one user using said head mount display with at least one of said plurality of predefined head movement positions.

15. A computer implemented method of controlling a menu based augmented reality (AR) Graphical User Interface (GUI) according to predefined head movement positions, comprising:
presenting at least one selection menu of a GUI displayed on an AR display of a head mounted display, said at least one selection menu comprising at least one of a plurality of control display objects;
detecting at least one of a plurality of predefined discrete head movement positions of said head mounted display by analyzing sensory data received from at least one orientation sensor monitoring orientation of said head mounted display, each of said plurality of predefined discrete head movement positions maps one of a plurality of navigation actions;
applying a respective navigation action mapped by said at least one detected predefined discrete head movement position on a currently selected control display object of said plurality of control display objects.
